(19) United States
(12) Patent Application Publication
(10) Pub. No.: US 2011/0019576 A1
(43) Pub. Date: Jan. 27, 2011

(54) RADIO QUALITY ESTIMATION SYSTEM, RADIO QUALITY ESTIMATION DEVICE, RADIO QUALITY ESTIMATION METHOD, AND RADIO QUALITY ESTIMATION PROGRAM

(75) Inventors: Kosei Kobayashi, Tokyo (JP); Takayuki Nyu, Tokyo (JP)

Correspondence Address: Mr. Jackson Chen, 6535 N. STATE HWY 161, IRVING, TX, 75039, US

(73) Assignee: NEC CORPORATION, Tokyo (JP)

(21) Appl. No.: 12/922,797

(22) PCT Filed: Mar. 27, 2009
(86) PCT No.: PCT/JP2009/056223

§ 371 Date: Sep. 15, 2010

(30) Foreign Application Priority Data
Mar. 28, 2008 (JP) 2008-087869

(51) Int. Cl. H04L 12/26

(52) U.S. Cl. 370/252

(57) ABSTRACT

Provided is a radio quality estimation system for estimating radio quality in consideration of environment information which changes with the passage of time and for judging by when to implement the preventive measures of the quality deterioration by taking the quality deterioration in the future into consideration. The radio quality estimation system is characterized by comprising an environment information storage section for storing the environment information which affects the radio quality in a target area and which changes with the passage of time, a radio wave propagation analysis section for analyzing the propagation characteristics of radio waves, and a radio quality estimation section for estimating the radio quality at a point in the target area by using the analyzed propagation characteristics of the radio waves and the obtained environment information.

### TECHNICAL FIELD

The present invention relates to a system for estimating wireless quality (radio quality) in wireless communications. Particularly, it relates to a wireless quality estimating system, a wireless quality estimating apparatus, a wireless quality estimating method, and a wireless quality estimating program for estimating wireless quality in cell-based wireless communications while taking account of a temporal change of an environment.

### BACKGROUND ART

In a cell-based wireless communications network, a wide area is divided into sub-regions referred to as wireless cells, and the network is comprised of planar service areas. In general, one wireless base station accommodates one to about ten wireless cells. In positioning wireless base stations and designing wireless configuration parameters (for example, the azimuth, tilt, power, etc. of an antenna for each wireless cell), a wireless quality estimating system based on a radio wave propagation simulator is used. This wireless quality estimating system estimates a planar distribution of wireless quality in an area by analyzing the status of propagation of radio waves from wireless base stations based on information on wireless base stations, geographical information, etc.

Wireless quality is affected by an environment (for example, a distribution of buildings, roads, and vegetation) of an area in which wireless communications are made. The wireless quality is also affected by the traffic of wireless communications in the area. For example, a place surrounded by high buildings often assumes poor wireless quality because radio waves from wireless base stations cannot easily reach the place. Moreover, as the number of service subscribers becomes larger and the traffic in a wireless cell is increased, wireless quality of user terminals lying in the periphery of the wireless cell is degraded due to interference because of limitation of the transmission power capacity of the wireless base station or user terminals. In other words, a virtual radius of a wireless cell is reduced. The change of the radius of a wireless cell caused by the traffic in a wireless base station is generally referred to as cell breathing.

As described above, the wireless quality is significantly affected by an environment (including the traffic) of an area. The environment dynamically varies over time. In other words, the environment is generally not static. Accordingly, in estimating the wireless quality, how to provide information on an environment at a time of interest for analysis is an important issue. Especially, information on buildings and traffic is important because of its great influence on the wireless quality.

Patent Document 1 discloses a technique of creating information on buildings using a dedicated software tool based on digital map information.

Patent Documents 2 and 3 disclose a technique of predicting traffic in the feature based on measured traffic in the past.

Patent Document 4 discloses a technique of remotely monitoring a change, if any, within coverage of a base station (for example, a high building having been built in the vicinity of a base station) in real time. Particularly, the environmental change, such as construction of a building, is detected per se in real time during operation based on an actual measurement of the change within coverage of a base station.

Patent Document 5 discloses a technique as follows: First, an object-oriented modeling technique is used to create conditions of a configuration of a wireless network to be evaluated. Based on the conditions, components of the wireless network are modeled as object-oriented data. Subsequently, the modeled components undergo simulation to predict quality of service on a base station by base station basis. A network cost required to implement the system is also calculated.

### [Prior Art Documents]

Patent Document 1: JP-P2002-49298A

Patent Document 2: JP-P2002-530957A

Patent Document 3: JP-P2000-14003A

Patent Document 4: JP-P2005-80113A

Patent Document 5: JP-P1995-283778A

### DISCLOSURE OF THE INVENTION

### Problems to be Solved by the Invention

However, the wireless quality estimating systems as disclosed in Patent Documents 1, 2, 3 focus upon, for example, completed buildings regarding the building information. Accordingly, information on buildings that are planned (or being currently constructed) and are not on the maps cannot be used. Moreover, a main object of Patent Documents 1, 2, 3 is to predict a time at which resources suffer from shortage. Accordingly, there is no disclosure about a traffic prediction technique for estimating a geographical change of the wireless quality with an increase of the traffic.

That is, the wireless quality estimating systems according to Patent Documents 1, 2, 3 cannot achieve estimation of the wireless quality while taking account of an environmental change (construction of a new building or increase of traffic). Hence, they cannot predict degradation of quality in the future in an area in which required quality should be promised. Therefore, the wireless quality estimating systems according to Patent Documents 1, 2, 3 cannot decide by when precautionary measures against degradation of quality, such as additional installment of a base station or tuning, should be taken while taking account of degradation of quality in the future.

The technique according to Patent Document 4 cannot estimate in advance a change of a planar distribution of the wireless quality within an area, which change is caused by an environmental change such as construction of a building, in correlation with the time at which the environmental change occurs. Therefore, the technique according to Patent Document 4 cannot decide by when precautionary measures against degradation of quality should be taken while taking account of degradation of quality in the future.

In Patent Document 5, an object of evaluation is service quality per base station such as, for example, a call loss probability, not wireless quality within an area. Moreover, the technique is configured to generate traffic conditions and geographical conditions using traffic data, equipment data, etc. in a region to be evaluated. However, Patent Document 5 does not disclose a particular method of providing traffic conditions and geographical conditions in the future. Specifically, an object of evaluation in the wireless quality estimating system according to Patent Document 5 is quality of service at a certain time point. The wireless quality estimating system according to Patent Document 5 cannot estimate the wireless quality while taking account of information on an environment varying with time. It also cannot decide by when precautionary measures against degradation of quality should be taken while taking account of degradation of quality in the future.

Accordingly, a problem to be solved by the present invention is to provide a technique for solving the aforementioned problems. Particularly, it is an object of the present invention to provide a wireless quality estimating system, a wireless quality estimating apparatus, a wireless quality estimating method, and a wireless quality estimating program for estimating the wireless quality while taking account of information on an environment varying with time, and deciding by when precautionary measures against degradation of quality should be taken while taking account of degradation of quality in the future.

### Means for Solving the Problems

The present invention for solving the aforementioned problem is a wireless quality estimating system comprising: an environmental information storage for storing therein information on an environment that affects wireless quality in an area of interest and varies with time; a radio wave propagation analyzing unit for analyzing propagation properties of radio waves; and a wireless quality estimating unit for estimating wireless quality at a spot within said area of interest using the propagation properties of radio waves analyzed by said radio wave propagation analyzing unit and the information on an environment acquired from said environmental information storage.

The present invention for solving the aforementioned problem is a wireless quality estimating apparatus comprising: an environmental information storage for storing therein information on an environment that affects wireless quality in an area of interest and varies with time; a radio wave propagation analyzing unit for analyzing propagation properties of radio waves; and a wireless quality estimating unit for estimating wireless quality at a spot within said area of interest using the propagation properties of radio waves analyzed by said radio wave propagation analyzing unit and the information on an environment acquired from said environmental information storage.

The present invention for solving the aforementioned problem is a wireless quality estimating method comprising: analyzing propagation properties of radio waves; and estimating wireless quality at a spot within an area of interest using said analyzed propagation properties of radio waves and information on an environment acquired from an environmental information storage in which information on an environment that affects wireless quality in said area of interest and varies with time is stored.

The present invention for solving the aforementioned problem is a wireless quality estimating program for causing a computer to execute the processing of: analyzing propagation properties of radio waves; and estimating wireless quality at a spot within an area of interest using said analyzed propagation properties of radio waves and information on an environment acquired from an environmental information storage in which information on an environment that affects wireless quality in said area of interest and varies with time is stored.

### EFFECTS OF THE INVENTION

According to the present invention, estimation of wireless quality can be achieved while taking account of information on an environment that varies with time.

### BRIEF DESCRIPTION OF THE DRAWINGS

FIG. 1 A block diagram of a wireless quality estimating system in accordance with a second embodiment of the present invention.

FIG. 2 An explanatory diagram showing an example of information on wireless base stations stored in a base station information storage in the second embodiment of the present invention.

FIG. 3 An explanatory diagram showing an example of information on a building kept by an environmental information storage in a first embodiment of the present invention.

FIG. 4 An explanatory diagram showing a method of predicting a height of a building under construction in the second embodiment of the present invention.

FIG. 5 An explanatory diagram showing an example of information kept by a significant spot storage in the second embodiment of the present invention.

FIG. 6 A flow chart showing an exemplary operation of the wireless quality estimating system in the second embodiment of the present invention.

FIG. 7 An explanatory diagram showing exemplary viewport display in the second embodiment of the present invention.

FIG. 8 An explanatory diagram showing an example of information on traffic kept by an environmental information storage in a third embodiment of the present invention.

FIG. 9 An explanatory diagram showing a method of predicting traffic in the future in the third embodiment of the present invention.

FIG. 10 A flow chart showing another exemplary operation of a wireless quality estimating system in the third embodiment of the present invention.

FIG. 11 A block diagram of a wireless quality estimating system in a fourth embodiment of the present invention.

FIG. 12 A flow chart showing an exemplary operation of the wireless quality estimating system in the fourth embodiment of the present invention.

FIG. 13 A block diagram of a wireless quality estimating system in a fifth embodiment of the present invention.

FIG. 14 A flow chart showing an exemplary operation of the wireless quality estimating system in the fifth embodiment of the present invention.

FIG. 15 An explanatory diagram showing exemplary viewport display in the fifth embodiment of the present invention.

FIG. 16 A flow chart showing an exemplary operation of the wireless quality estimating system in the third embodiment of the present invention.

FIG. 17 A block diagram of a wireless quality estimating system in accordance with the first embodiment of the present invention.

FIG. 18 A flow chart showing an exemplary operation of the wireless quality estimating system in the first embodiment of the present invention.

### EXPLANATION OF SYMBOLS

1 Wireless quality estimating system
2 Exemplary viewport display
10 Input device
20 Data processing apparatus
21 Lower left portion of viewport (Input section for specifying date and time of interest for analysis, and commanding estimation of wireless quality)
22 Upper left portion of viewport (Display area for wireless quality)
23 Upper right portion of viewport (Description of display)
24 Lower right portion of viewport (Due date for taking measures for each significant spot)
30 Storage unit
40 Output device
201 Radio wave propagation analyzing section (Radio wave propagation analyzing section)
202 Wireless quality estimating section (Wireless quality estimating section)
203 Quality deciding section (Quality deciding section)
204 Environmental information predicting section (Environmental information predicting section)
205 Due-date-for-taking-measures predicting section (Due-date-for-taking-measures predicting section)
301 Base station information storage
302 Geographical information storage
303 Environmental information storage
304 Significant spot storage

### BEST MODES FOR CARRYING OUT THE INVENTION

Now several embodiments of the present invention will be described with reference to the accompanying drawings.

### First Embodiment

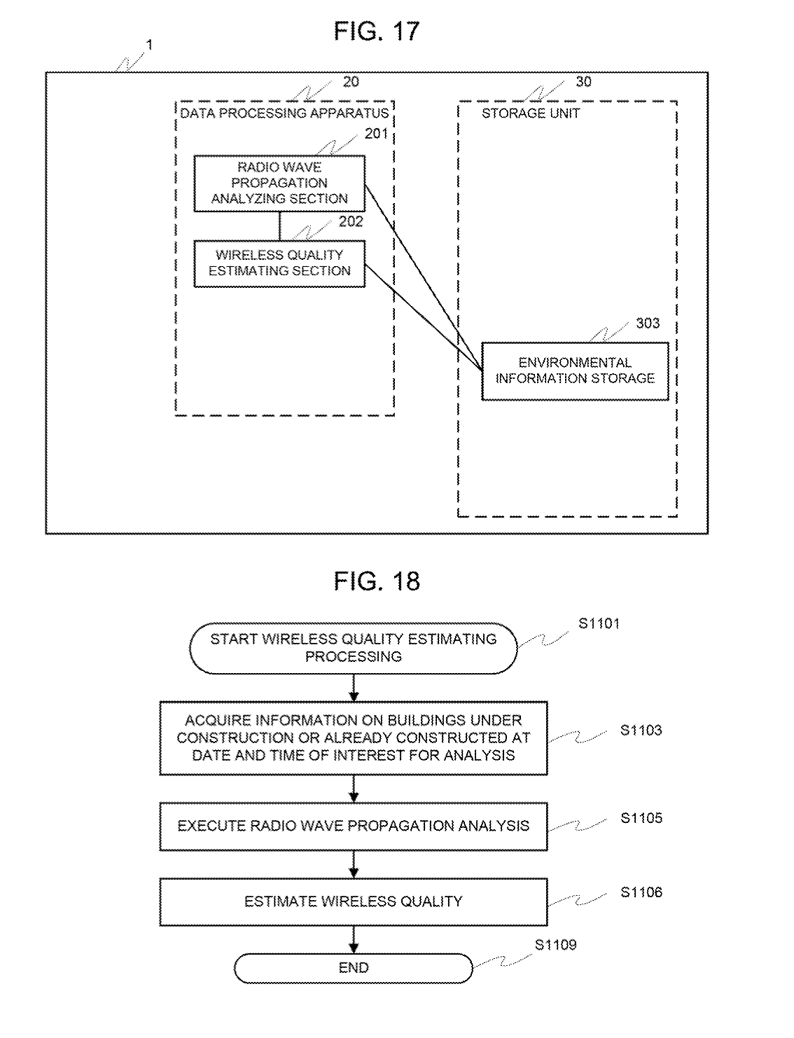

FIG. 17 is a block diagram of a wireless quality estimating system in accordance with a first embodiment of the present invention.

A wireless quality estimating system 1 comprises a data processing apparatus 20 operated by program control, and an information storage unit 30 for storing therein information.

The information storage unit 30 includes an environmental information storage 303.

The environmental information storage 303 stores therein information on an environment (which affects wireless quality and varies with time) in correlation with time information. The information on an environment stored in the environmental information storage 303 includes buildings, roads, vegetation, and traffic in the current area. The information is merely illustrative. Specifically, the information on an environment is information that affects wireless quality.

The data processing apparatus 20 comprises a radio wave propagation analyzing section 201 and a wireless quality estimating section 202. The radio wave propagation analyzing section 201 analyzes propagation properties of radio waves. The wireless quality estimating section 202 estimates wireless quality at a spot within an area of interest for analysis.

The radio wave propagation analyzing section 201 analyzes propagation properties of radio waves using information on an environment acquired from the environmental information storage 303. The information used in analysis of propagation properties of radio waves is not limited to the information on an environment. In other words, at least information on an environment is used.

The area of interest for analysis is specified using information on a position (the place name, the name of an area defined in advance, the name of a wireless base station, longitude and latitude, etc.). The date and time of interest for analysis may be specified as a standard date and time (for example, YYYY-MM-DD) or a relative time from a certain base date (for example, after DD days, or the like). It should be noted that the date and time of interest for analysis are not limited to the date-time data. For example, date data or time data may be used.

Radio wave propagation analysis may be achieved by, for example, calculating a propagation loss for transmitted radio waves, a delay time, etc. for an antenna in each wireless base station and for a spot within an area. Methods of analyzing radio wave propagation include, for example, statistic techniques such as the Hata-Okumura Model (i.e., a statistic technique with which a propagation curve representing propagation properties of radio waves is statistically modeled based on measurements). Another technique that may be contemplated is a ray tracing method (with which propagation properties of radio waves are deterministically predicted by a technique according to geometrical optics). It should be noted that particular methods for analyzing radio wave propagation are commonly known. Therefore, detailed description thereof will be omitted.

The wireless quality estimating section 202 estimates wireless quality at a spot within an area using propagation properties of radio waves (a result of radio wave propagation analysis by the radio wave propagation analyzing section 201) and information on an environment (that acquired from the environmental information storage 303). This wireless quality may include a received signal code power (RSCP) for a desired wave and a ratio of energy per chip of a desired wave to in-band received power density (Ec/NO) for a common pilot channel (CPICH), and a signal to interference ratio (SIR). A specific method of estimating wireless quality will be described later.

Now an example of information stored in the environmental information storage 303 will be described hereinbelow.

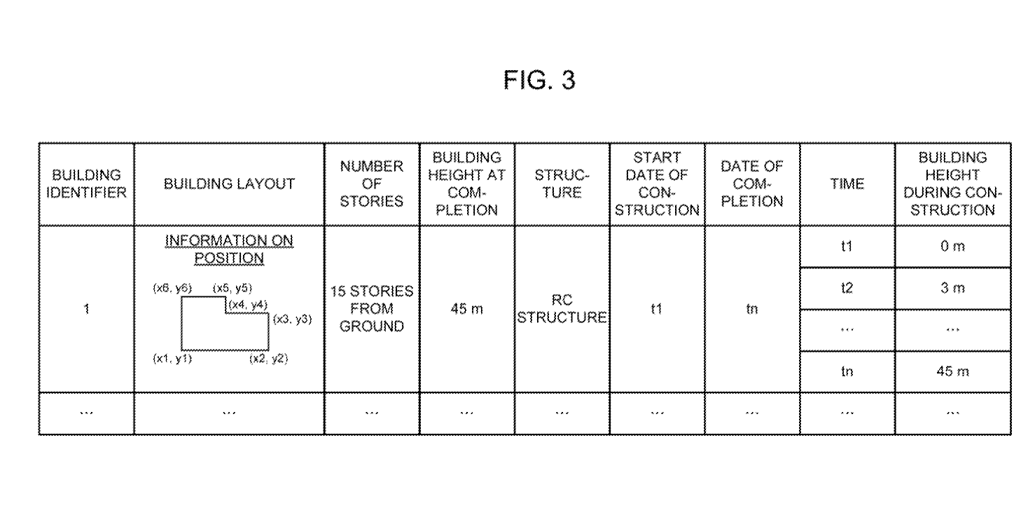

FIG. 3 shows an example of information stored in the environmental information storage 303. The environmental information storage 303 stores therein a change of the height of a building from the start date of construction to the date of completion in correlation with time (see FIG. 3). The start date of construction, the date of completion, the building height at the completion, the number of stories, the structure, the building layout, and the like are available from, for example, documents disclosed at a municipal office, etc. such as Summary of Construction Project.

Next, the operation of this embodiment will be described hereinbelow (see FIG. 18).

Once the radio wave propagation analyzing section 201 has received information on a specified area of interest for analysis and date and time of interest for analysis, the wireless quality estimating section 202 starts processing (S1101).

The radio wave propagation analyzing section 201 acquires information on an environment, such as information on a building under construction and information on a building already constructed at the date and time of interest for analysis, from the environmental information storage 303 (S1103).

The radio wave propagation analyzing section 201 executes radio wave propagation analysis based on the information on an environment acquired from the environmental information storage 303 (S1105).

As a result of the radio wave propagation analysis by the radio wave propagation analyzing section 201, a propagation loss, a delay time, etc. of radio waves transmitted from an antenna are determined for each antenna of each wireless base station contained in the area of interest for analysis.

The wireless quality estimating section 202 uses the result of radio wave propagation analysis by the radio wave propagation analyzing section 201 and the information on an environment acquired from the environmental information storage 303 to estimate wireless quality in a region containing a spot within that area (S1106).

As discussed above, the first embodiment is configured to enable estimation of wireless quality at a spot within an area of interest for analysis based on information on a building (which affects wireless quality and varies with time) acquired from the environmental information storage 303, and a result of radio wave propagation analysis by the radio wave propagation analyzing section 201. It is thus possible to estimate wireless quality while taking account of a building under construction or a building planned to be constructed in the future.

### Second Embodiment

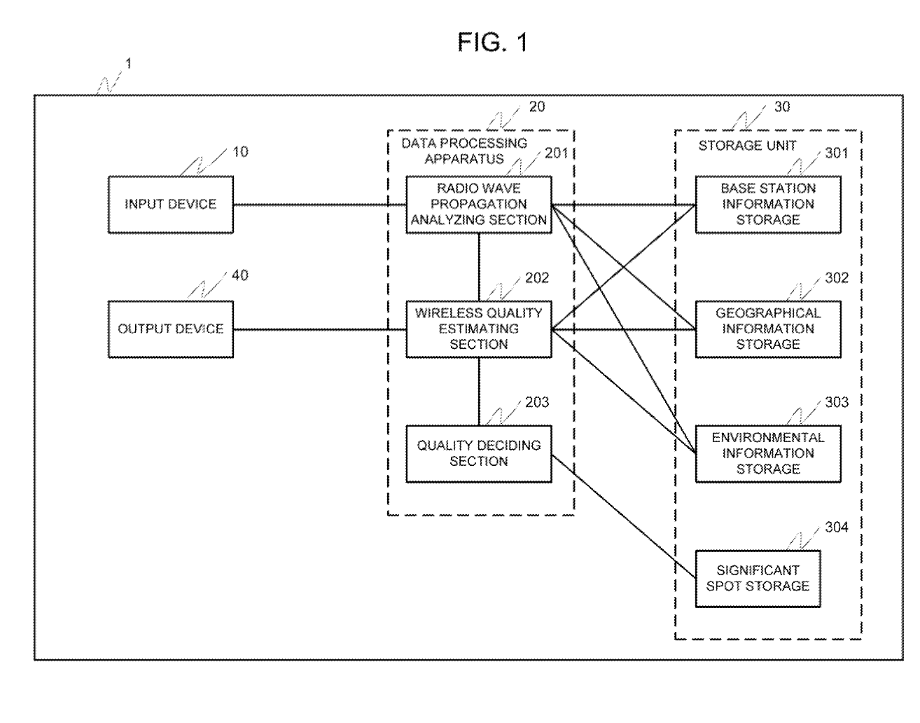

FIG. 1 is a block diagram of a wireless quality estimating system in accordance with a second embodiment of the present invention.

The wireless quality estimating system 1 comprises the wireless quality estimating system of the first embodiment, additionally provided with an input device (for example, a keyboard, a mouse, etc.) 10, and an output device (such as a display device) 40.

The storage unit 30 comprises a base station information storage 301, a geographical information storage 302, and a significant spot storage 304.

The base station information storage 301 stores therein information on wireless base stations disposed within an area.

The geographical information storage 302 stores therein geographical information (such as, for example, topography, buildings, roads, railways, rivers, etc., which are provided as a digital map from the Geospatial Information Authority of Japan or map makers). Particularly, the geographical information is stored in correlation with information on a position (information represented by latitude and longitude or information on a position in X-Y Cartesian coordinates). It should be noted that digital maps represent geographical information at a certain time point in the past. Hence, digital maps do not contain information on buildings under construction and yet to be completed, buildings planned to be constructed in the future, or the like.

The significant spot storage 304 stores therein information on significant spots at which required quality should be promised. The significant spot and required quality will be described later.

The data processing apparatus 20 comprises a radio wave propagation analyzing section (equivalent to the radio wave propagation analyzing section in the aforementioned embodiment) 201, a wireless quality estimating section (equivalent to the wireless quality estimating section in the aforementioned embodiment) 202, and a quality deciding section 203.

The quality deciding section 203 uses a result of estimation by the wireless quality estimating section 202 (a result of estimation of wireless quality at a spot within an area of interest) to decide whether wireless quality in a specific region containing the spot within the area satisfies required quality. For example, the quality deciding section 203 uses a distribution of Wireless quality at spots within an area estimated by the wireless quality estimating section 202, and information on significant spots stored in the significant spot storage 304 to decide wireless quality at the significant spots satisfies required quality. The required quality is defined as, for example, a received signal code power for a desired wave of −70 dBm or higher, and a ratio of energy per chip of a desired wave to in-band received power density of −6 dB or higher, as shown in FIG. 5. It should be noted that the required quality may be defined on a significant spot by spot basis. Alternatively, it may be defined in common among all significant spots.

Next, examples of information stored in the base station information storage 301, environmental information storage 303, and significant spot storage 304 will be described hereinbelow. It should be noted that a specific data format or the like of information stored in the geographical information storage 302 is not directly related to the present invention, and therefore, detailed description thereof will be omitted.

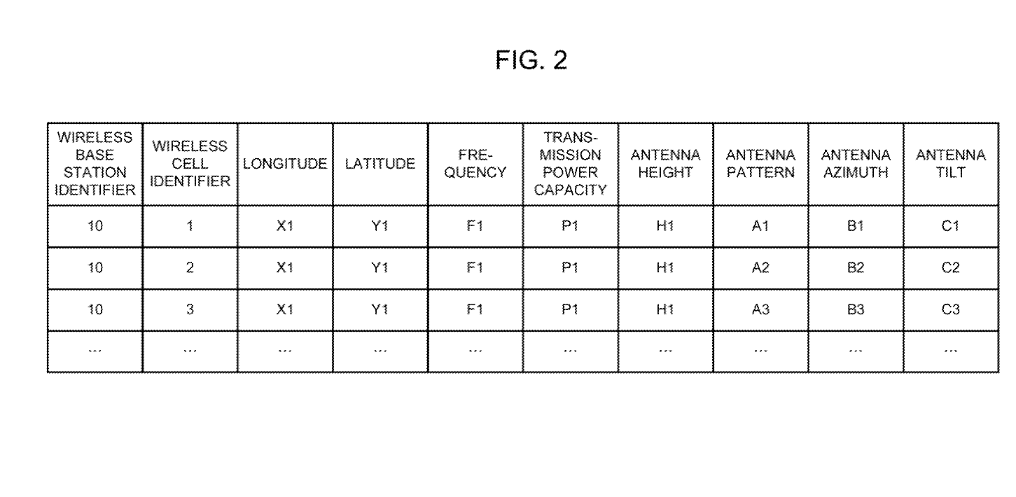

An example of information on wireless base stations stored in the base station information storage 301 is shown in FIG. 2. The base station information storage 301 stores therein, for each wireless cell subordinate to a wireless base station, information on a position (latitude, longitude) of the current wireless cell, a frequency, a transmission power capacity (the maximum transmittable electric power), and antenna information (for example, antenna height, antenna pattern, antenna azimuth, antenna tilt), in correlation with a wireless cell identifier and a wireless base station identifier.

An example of information stored in the significant spot storage 304 is shown in FIG. 5. The significant spot storage 304 stores therein, for each significant spot, information on a position (for example, longitude, latitude) representing that spot, a description of the spot, and required quality to be satisfied, in correlation with an identifier indicating the spot. The significant spots that may be contemplated include places which are highly public and where people gather, such as, for example, stations, department stores, and market streets. The significant spot may be defined by one coordinate point. Alternatively, it may be defined as a region represented by a plurality of coordinate points.

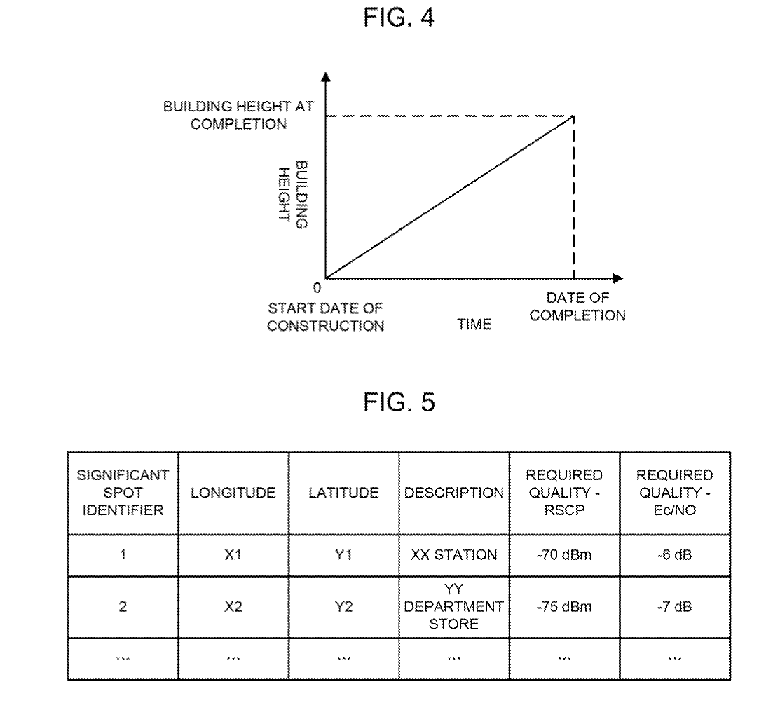

FIG. 4 is a diagram showing a method of predicting a height of a building under construction. A height of a building in a period from a start date of construction to a date of completion can be estimated using linear interpolation from the start date of construction, the date of completion, and a height of the building at the completion, as shown in FIG. 4. Methods of estimating a temporal change of the height of a building are not limited thereto. For example, in a case that detailed information on the construction plan in which the correlation of the time and the height of a building is included is available in advance, a temporal change of the height of the building is estimated based on that information.

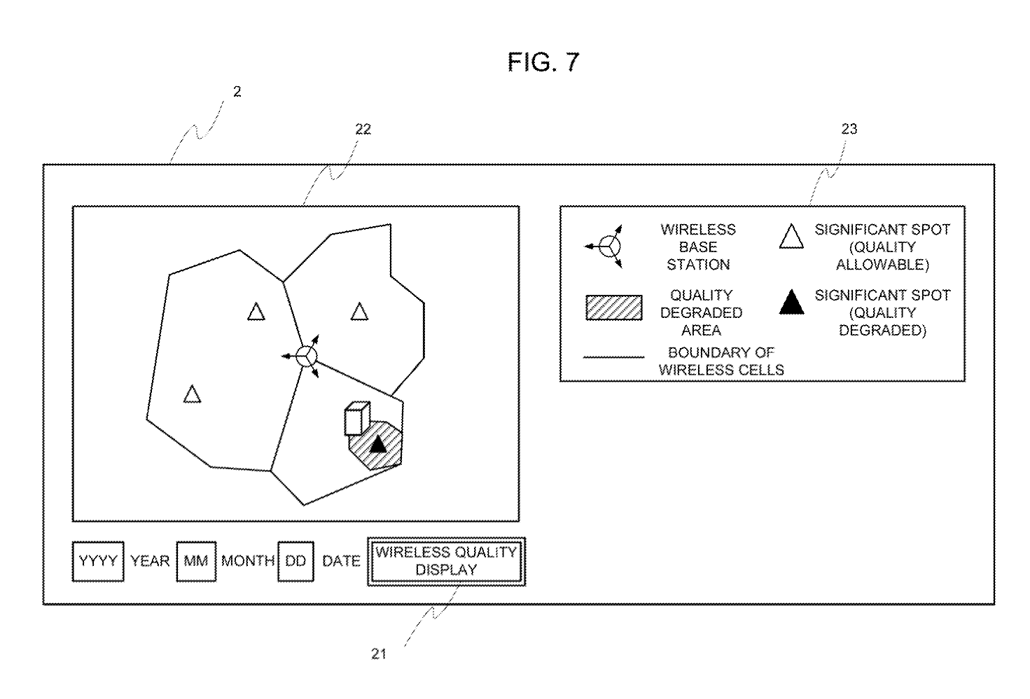

FIG. 7 is a diagram of exemplary viewport display by an output device 40 in the second embodiment. In the exemplary viewport display 2 shown in FIG. 7, once a date and time of interest for analysis has been specified via an input section 21 lying in the lower left portion of the viewport to command display of wireless quality, information including wireless base stations, significant spots, wireless quality, etc. is displayed in a display section 22 lying in the upper left portion of the viewport along with a map of the current area. A description section 23 lying in the upper right portion of the viewport shows a detailed description of the display section 22.

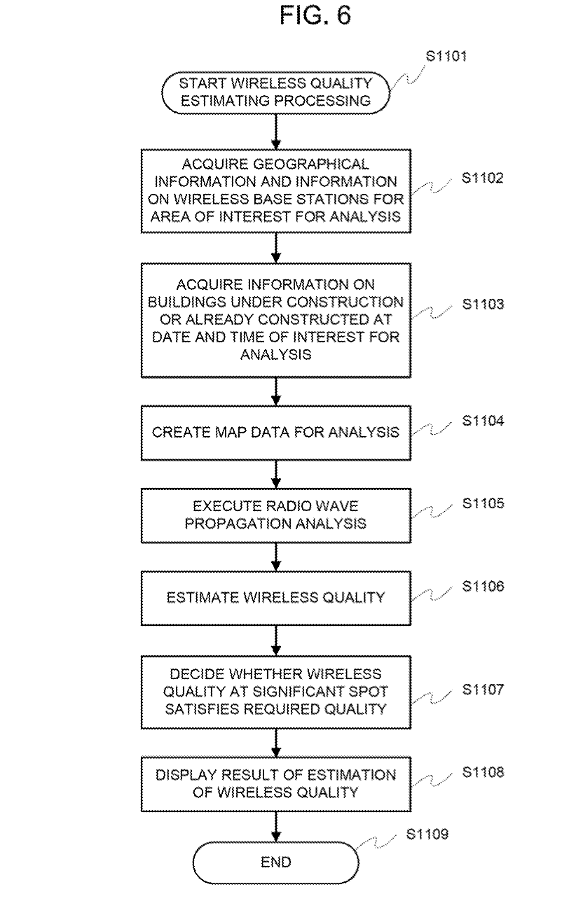

Next, the operation of this embodiment will be described hereinbelow (see FIG. 6).

Via the input device 10 are input an area of interest for analysis and a date and time of interest for analysis. Thus, the radio wave propagation analyzing section 201 acquires information for the specified area of interest for analysis and date and time of interest for analysis. The wireless quality estimating section 202 then starts processing (S1101). The area of interest for analysis is specified using a place name, a name of an area defined in advance, a name of a wireless base station, and information on a position such as latitude and longitude. The date and time of interest for analysis is generally specified using a date and time, or an elapsed time from a base date.

The radio wave propagation analyzing section 201 acquires information on a wireless base station (contained in the current area, from the base station information storage 301), geographical information (for the area of interest for analysis, from the geographical information storage 302), and information on an environment (acquired from the environmental information storage 303) (S1102, S1103).

The radio wave propagation analyzing section 201 uses the geographical information acquired from the geographical information storage 302 and the information on an environment acquired from the environmental information storage 303 to create map data for analysis (S1104).

Based on the map data for analysis created at S1104, the radio wave propagation analyzing section 201 performs radio wave propagation analysis (S1105). As a result of the radio wave propagation analysis, a propagation loss, a delay time, etc. of radio waves transmitted from an antenna are determined for each antenna of each wireless base station contained in the area of interest for analysis, at an arbitrary spot in that area.

The wireless quality estimating section 202 uses the result of radio wave propagation analysis by the radio wave propagation analyzing section 201, and information on a wireless base station acquired from the base station information storage 301 to estimate wireless quality at a spot in the area of interest for analysis (S1106). The wireless quality to be estimated may include, for example, a received signal code power for a desired wave for a common pilot channel, a ratio of energy per chip of a desired wave to in-band received power density for a common pilot channel, and a signal to interference ratio.

An example of estimation of wireless quality by the wireless quality estimating section 202 will be described hereinbelow.

For example, for radio waves transmitted from a certain wireless cell A, an RSCP [dBm] for a common pilot channel at a reception point X is obtained by Equation (1) below:

$$\begin{matrix}[ Equation 1 ] & \\ RSCP [ dBm ] = 10 \cdot {log}_{10} ( {10}^{\frac{P}{10}} \cdot α ) + L - k & ( 1 )\end{matrix}$$

where

P: a transmission power capacity [dBm],

α: a proportion of the transmission power for the common pilot channel in the transmission power capacity,

L: a propagation loss at reception point X [dB], and

k: a noise [dB] generated at a transmitter and a receiver.

For example, assuming that P=40 [dBm], α=0.1, L=−110 [dB], and k=3 [dB], RSCP=−83 [dBm].

The SIR and Ec/NO [dB] for the common pilot channel at reception point X are obtained by Equations (2) and (3) below:

$$\begin{matrix}[ Equation 2 ] & \\ SIR = SF \cdot \frac{RSCP [ mW ]}{{I}_{own} \cdot ( 1 - ɛ ) + {I}_{oth} + {P}_{N}} & ( 2 )\end{matrix}$$

where

I_{own}: a total received power [mW] at reception point X from an own cell (a wireless cell having the highest RSCP at reception point X),

Iₒₜₕ: a total received power [mW] at reception point X from other wireless cells,

Pₙ: a thermal noise [mW],

ε: an orthogonality factor (0≦ε≦1), and

SF: a splitting factor.

$$\begin{matrix}[ Equation 3 ] & \\ Ec / NO [ dB ] = 10 \cdot {log}_{10} ( \frac{1}{( SF / SIR ) + 1} ) & ( 3 )\end{matrix}$$

Regarding ε, it is assumed that interference in the own cell is reduced by using mutually orthogonal spreading codes. Specifically, in a case that the spreading codes are completely orthogonal, ε=1, which means that interference in the own cell is fully suppressed. For a common pilot channel, SF=256 (a fixed value). The total received power from the own cell I_{own} and the total received power from other wireless cells Iₒₜₕ depend upon the traffic occurring at the date and time. The total received power may be estimated on a wireless cell by wireless cell basis simply by multiplying RSCP for each cell at a reception point by a respective fixed coefficient.

The quality deciding section 203 decides whether wireless quality at a significant spot contained in the area of interest for analysis satisfies required quality for each significant spot (S1107) based on a distribution of wireless quality estimated (S1106) by the wireless quality estimating section 202, and information on significant spots acquired from the significant spot storage 304. The quality deciding section 203 outputs the result of the decision to the wireless quality estimating section 202.

The output device 40 then outputs the distribution of wireless quality (at the spot within the area of interest for analysis) estimated by the wireless quality estimating section 202, and the result of quality decision by the quality deciding section 203 (for each significant spot within the current area), overlaid over map information about the current area (S1108). Once the output device 40 has output the distribution of wireless quality and the result of quality decision, the wireless quality estimating processing is terminated (S1109).

As discussed above, in the second embodiment, decision is made as to whether a significant spot lying within an area of interest satisfies required quality. Therefore, knowledge about when degradation of quality may occur at the significant spot can be obtained in advance. This enables precautionary measures against degradation of quality to be taken.

### Third Embodiment

A third embodiment will be described hereinbelow. It should be noted that information stored in the environmental information storage 303 in this embodiment is different from the information stored in the environmental information storage 303 (see FIG. 1) in the second embodiment described above.

The environmental information storage 303 stores therein information on traffic, in place of the information on a building used in the second embodiment. It should be noted that both the information on a building and information on traffic may be stored.

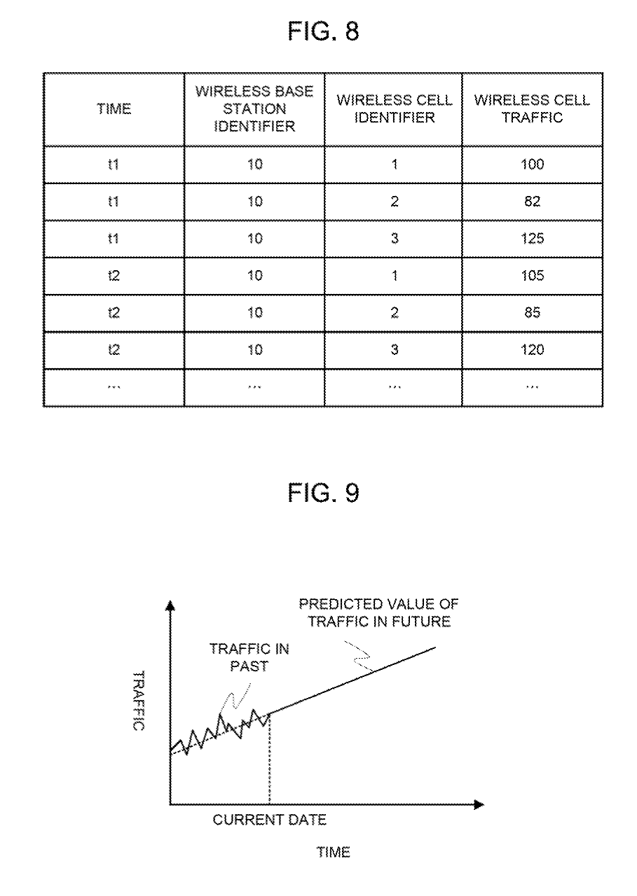

FIG. 8 shows an example of information on traffic stored in the environmental information storage 303. The traffic is stored on a wireless cell by cell basis in correlation with time (see FIG. 8). It should be noted that the traffic stored in the environmental information storage 303 preferably includes traffic in the past measured at the wireless base station for each wireless cell, and a predicted value of traffic in the future for that wireless cell.

FIG. 9 shows an example of predicted traffic in the future. For example, a general time-series prediction technique, such as regression analysis, may be used to predict traffic in the future from a time series of traffic in the past.

The traffic that may be contemplated for use is the number of requests for call connection for each wireless cell at a certain time point, or the total used power for each wireless cell. Alternatively, it may be contemplated to use the number of requests for call connection for each wireless cell or the total used power for each wireless cell in a certain period of time (a period of time such as one hour or one day, for example). Otherwise, it may be contemplated to use the statistical value, such as the average, mode or median, of the number of requests for call connection for each wireless cell (or the total used power for each wireless cell) in a certain period of time.

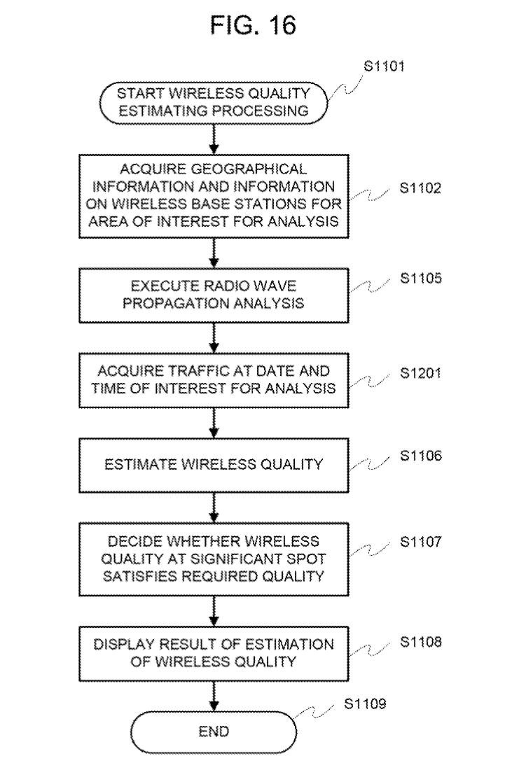

Next, the operation of this embodiment will be described hereinbelow (see FIG. 16).

Since S1101 and S1102 (see FIG. 16) are similar to those in the second embodiment, description thereof will be omitted.

The radio wave propagation analyzing section 201 performs acquires information on traffic from the environmental information storage 303, and performs radio wave propagation analysis (S1105).

Subsequently, the wireless quality estimating section 202 acquires traffic at a date and time of interest for analysis from the environmental information storage 303 (S1201). The acquired traffic at the date and time of interest for analysis is used to estimate wireless quality at a spot within an area of interest. In particular, as described earlier, when determining SIR and Ec/NO [dB] for a common pilot channel, the total received power from the own cell I_{own} and the total received power from other wireless cells Iₒₜₕ are calculated based on the acquired traffic. For example, the total used power for each wireless cell at the date and time of interest for analysis is acquired as traffic. The strength of an electric field of radio waves transmitted at that total used power from an antenna of each wireless cell at reception point X is calculated. The value is the total received power for each wireless cell at reception point X.

Since the operations thereafter (S1107-S1109) are similar to those in the aforementioned embodiments, detailed description thereof will be omitted.

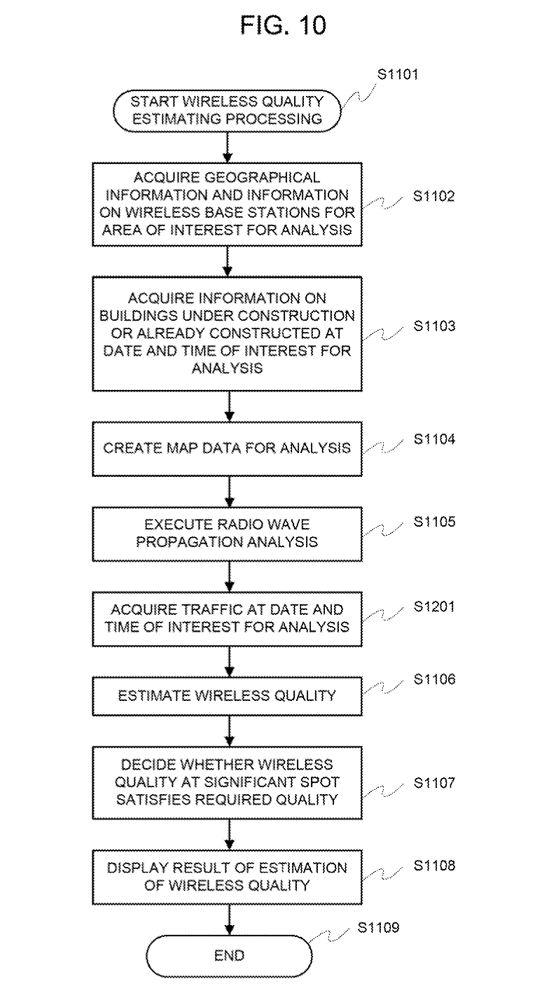

This embodiment addresses a case in which information on traffic, in place of the information on a building, is stored in the environmental information storage 303. However, information stored in the environmental information storage 303 is not limited thereto. For example, the environmental information storage 303 may store therein the information on a building and information on traffic. The operation in this case is shown in FIG. 10. Since the operation in this case can be basically understood from the description above, detailed description thereof will be omitted.

As discussed above, according to the third embodiment, wireless quality at a spot within an area of interest is estimated based on traffic (which is stored in advance, and which affects wireless quality and varies with time). Thus, the time and place at which degradation of wireless quality, such as reduction of the radius of a wireless cell due to an increase of traffic, may occur can be known. Therefore, knowledge about when degradation of quality may occur can be obtained in advance. This enables precautionary measures against degradation of quality to be taken.

### Fourth Embodiment

A fourth embodiment will be described hereinbelow.

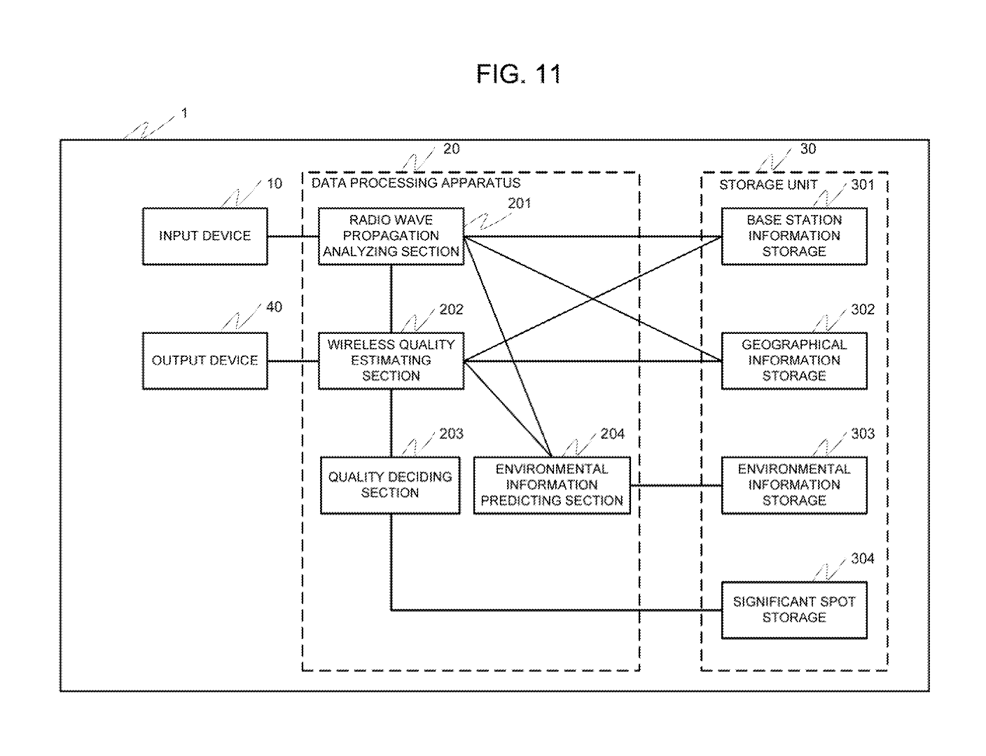

FIG. 11 is a block diagram of a wireless quality estimating system in accordance with the fourth embodiment of the present invention.

In the wireless quality estimating system of the fourth embodiment, the data processing apparatus 20 additionally comprises an environmental information predicting section 204 (see FIG. 11). Other configurations are generally similar to those in the aforementioned embodiments. Components similar to those in FIG. 1 are designated by similar reference symbols, and detailed description thereof will be omitted.

The environmental information predicting section 204 predicts information on an environment at an arbitrary time point based on information on an environment at a specific time point kept by the environmental information storage 303. For example, information on an environment stored in the environmental information storage 303 (particularly, that at least two time points) is used to predict information on an environment at a certain time point. For example, instead of storing a temporal change of the height of a building under construction in advance, the environmental information storage 303 is configured to estimate a height of a building using linear interpolation from a start date of construction of the building, a date of completion, and a height of the building at the completion (see FIG. 4). Moreover, instead of storing traffic in the future in advance, the environmental information storage 303 may be configured to predict (estimate) traffic in the future from a time series of traffic in the past using a general time-series prediction technique, such as regression analysis (see FIG. 9). In a case that the information on an environment predicted by the environmental information predicting section 204 is information on a building that affects propagation properties of radio waves, for example, the information on an environment is output to the radio wave propagation analyzing section 201. In a case that the information on an environment predicted by the environmental information predicting section 204 is information on traffic that affects wireless quality such as interference, for example, the information on an environment is output to the wireless quality estimating section 202.

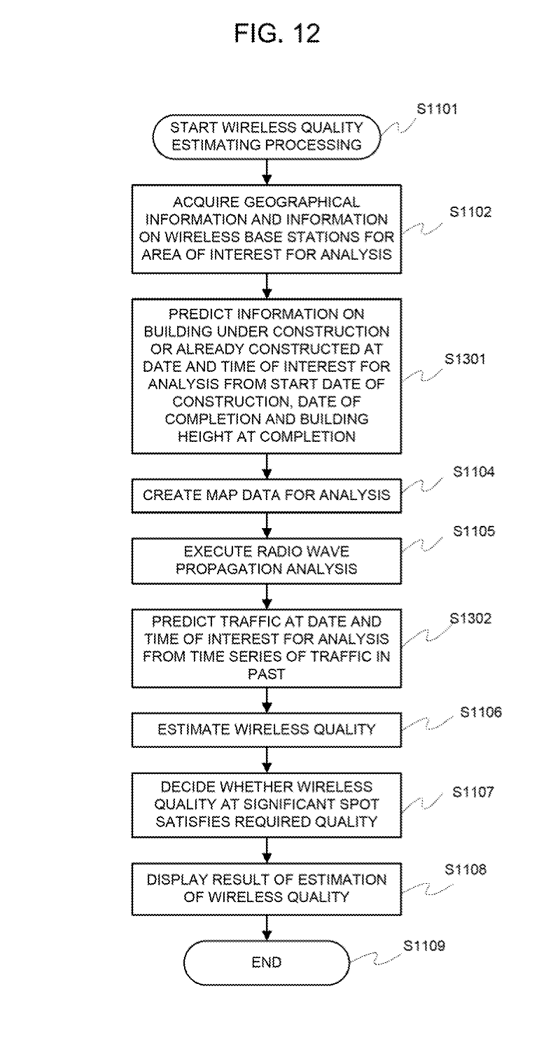

Next, the operation of this embodiment will be described hereinbelow (see FIG. 12).

In this embodiment, information on a building that is new at a date and time of interest for analysis is not acquired from the environmental information storage 303. Moreover, the traffic at the date and time of interest for analysis is not acquired from the environmental information storage 303. Instead, the environmental information predicting section 204 predicts information on an environment using information on a building stored in the environmental information storage 303 (S1301). The environmental information predicting section 204 also predicts information on an environment using information on traffic stored in the environmental information storage 303 (S1302). Other operations are similar to those in the aforementioned embodiments, and detailed description thereof will be omitted.

As discussed above, in the fourth embodiment, the environmental information predicting section 204 predicts information on a building that is new at a date and time of interest for analysis from a start date of construction of the building, a date of completion, and a height of the building at the completion. The environmental information predicting section 204 also predicts traffic at a date and time of interest for analysis from a time series of traffic in the past. That is, the environmental information predicting section 204 is configured to predict information on an environment at a date and time of interest for analysis from information on an environment already stored in the environmental information storage 303. Therefore, it is not necessary for the environmental information storage 303 to store information on an environment at all time points. Hence, the capacity size required in the environmental information storage 303 may be reduced. Moreover, continuous information on an environment can be predicted.

### Fifth Embodiment

A fifth embodiment will be described hereinbelow.

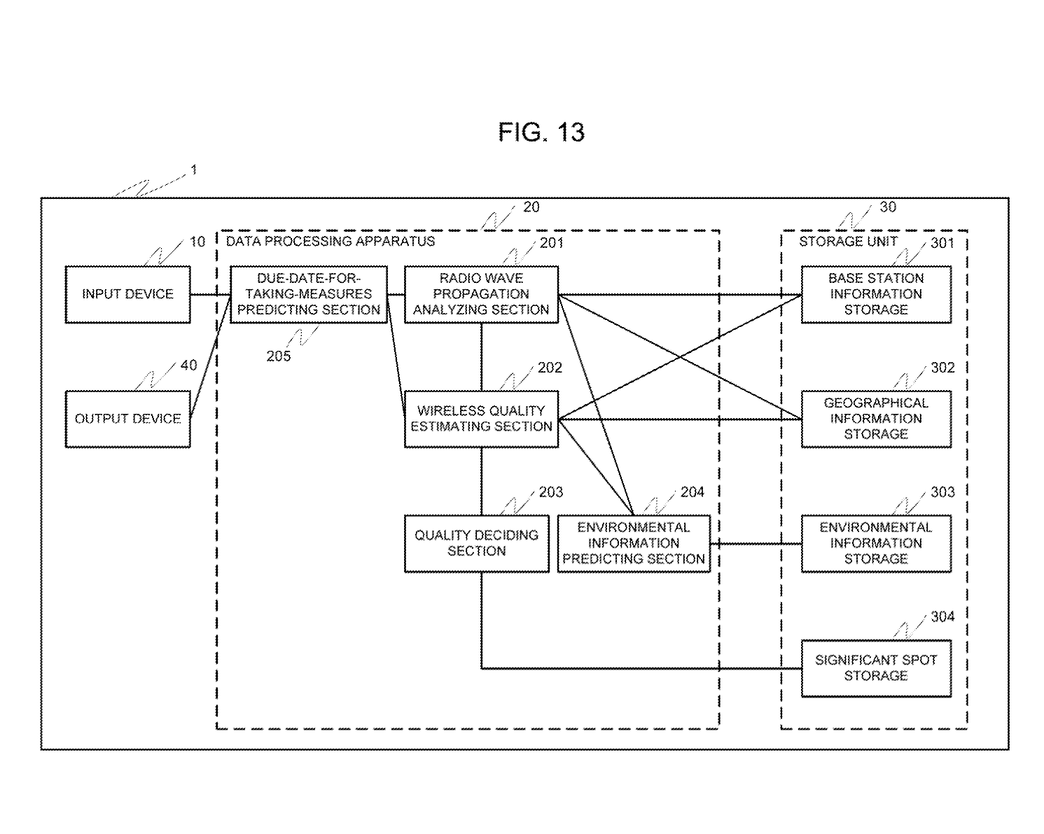

FIG. 13 is a block diagram of a wireless quality estimating system in accordance with the fifth embodiment of the present invention.

In the wireless quality estimating system of this embodiment, the data processing apparatus 20 additionally comprises a due-date-for-taking-measures predicting section 205. Other configurations are basically similar to those in the fourth embodiment. Components similar to those in FIG. 11 are designated by similar reference symbols, and detailed description thereof will be omitted.

The radio wave propagation analyzing section 201 uses information on an environment at a time point sequentially specified by the due-date-for-taking-measures predicting section 205 to analyze propagation properties of radio waves.

The wireless quality estimating section 202 uses the propagation properties of radio waves sequentially analyzed by the radio wave propagation analyzing section 201 and the information on an environment at a time point sequentially specified by the due-date-for-taking-measures predicting section 205 to estimate wireless quality. Prediction (estimation) of wireless quality by the wireless quality estimating section 202 from a start date of analysis to an end date of analysis is made at specific analysis intervals. The analysis interval may be a predetermined value. Alternatively, it may be input via the input device 10. For example, the analysis interval may be defined as one day, one week, ten days, or one month.

The due-date-for-taking-measures predicting section 205 increments the date of interest for analysis from an initial value of the start date of analysis until the end date of analysis is reached, based on the area (area of interest for analysis), the start date of analysis and the end date of analysis input via the input device 10, and predicts an expected date at which wireless quality at a significant spot will not satisfy required quality. Specifically, the due-date-for; taking-measures predicting section 205 commands the radio wave propagation analyzing section 201 and the wireless quality estimating section 202 to perform estimation of wireless quality from the start date of analysis to the end date of analysis based on the area, the start date of analysis, the end date of analysis, and predicts an expected date at which wireless quality at a significant spot stored in the significant spot storage 304 will not satisfy required quality.

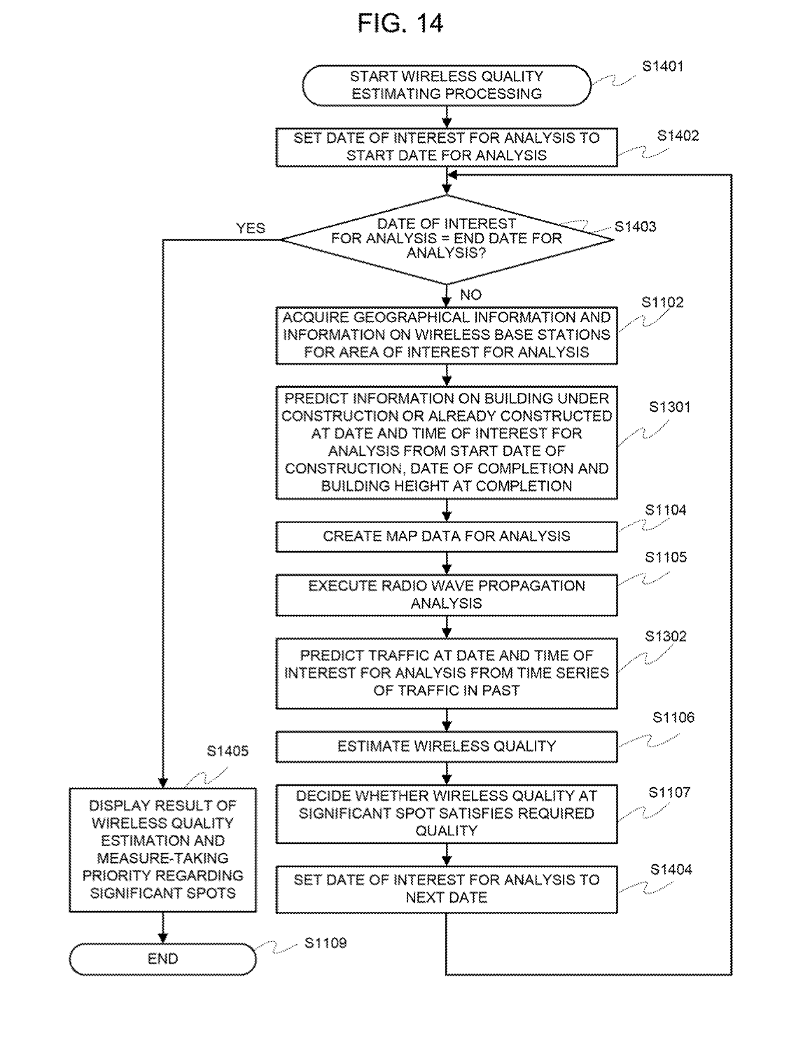

Next, the operation of this embodiment will be described hereinbelow (see FIG. 14). It should be noted that the analysis interval is set to one day in FIG. 14.

In this embodiment, once the area of interest for analysis, the start date of analysis and the end date of analysis have been input to the due-date-for-taking-measures predicting section 205, wireless quality estimating processing is started (S1401). This embodiment is similar to the fourth embodiment except that there are provided the step of sequentially updating the date of interest for analysis from the start date of analysis to the end date of analysis (S1402, S1403, S1404), and the step of, in displaying the result, displaying the measure-taking priority regarding significant spots in addition to the result of wireless quality estimation (S1405). Other operations are similar to those in the fourth embodiment. Specifically, once the area of interest for analysis, the start date of analysis and the end date of analysis have been input via the input device 10, the due-date-for-taking-measures predicting section 205 increments the date of interest for analysis from an initial value of the start date of analysis until the end date of analysis is reached, and predicts an expected date at which quality at a significant spot lying in the area of interest for analysis becomes lower than required quality. The output device 40 then outputs the date.

One example in which the analysis interval is set to one day is shown (see FIG. 14). In particular, the date of interest for analysis is defined as the start date of analysis (S1402). The date of interest for analysis is updated one by one until the end date of analysis is reached (S1404). Wireless quality at the date of interest for analysis is sequentially estimated. A decision is made as to whether the date of interest for analysis is the end date of analysis (S1403). In a case that the date of interest for analysis is decided to be the end date of analysis, the result of wireless quality estimation, and the measure-taking priority at a significant spot are displayed (S1405). The wireless quality estimating processing is then terminated.

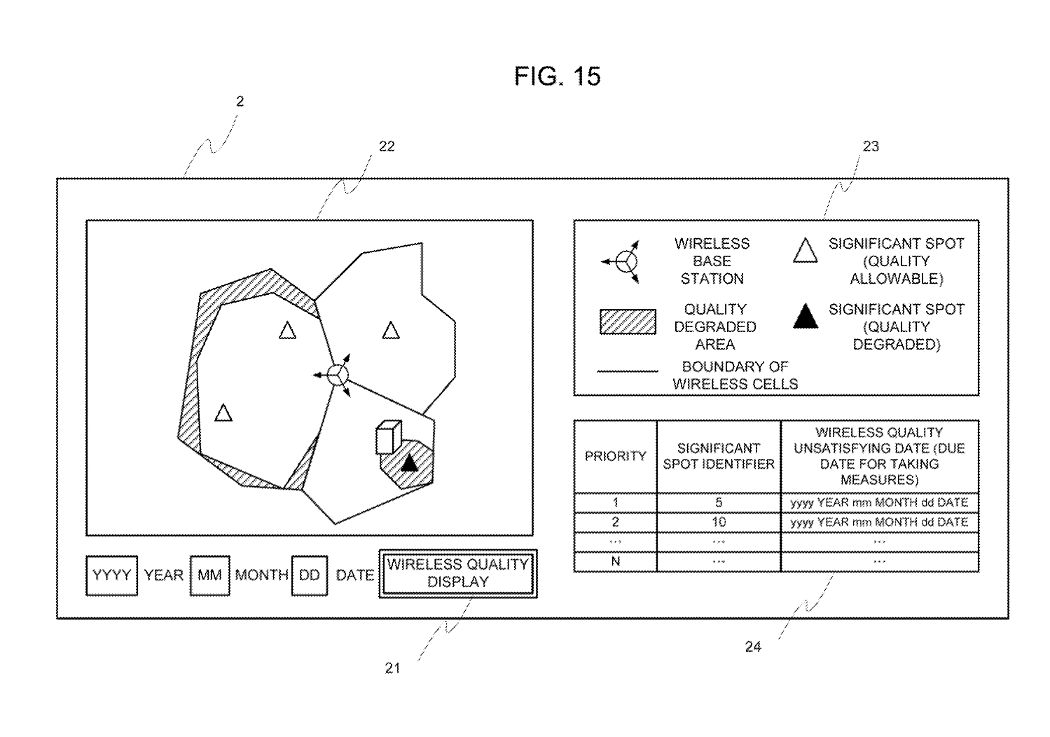

FIG. 15 shows an exemplary viewport displayed by the output device 40 in the fifth embodiment. The exemplary viewport display 2 in the fifth embodiment (see FIG. 15) is similar to that in the second embodiment (see FIG. 7) except that the date at which required quality is exceeded is displayed on a significant spot by spot basis in a lower right portion 24 of the viewport. It should be noted that the priority (the aforementioned measure-taking priority) on a significant spot by spot basis in the lower right portion 24 of the viewport may be set to a higher value in an ascending order of wireless quality (the order from poorer wireless quality) estimated by the wireless quality estimating section 202. Alternatively, the priority may be set to a higher value in a sequence from a required quality unsatisfying date (due date for taking measures), which is equivalent to the date at which wireless quality will not satisfy required quality among the sequentially updated dates of interest for analysis, closer to the current date. Such a setting may be input to the due-date-for-taking-measures predicting section 205 beforehand by operating the input device 10. Thus, it is possible for the due-date-for-taking-measures predicting section 205 to display the priority (the aforementioned measure-taking priority) on a significant spot by spot basis in the lower right portion 24 of the viewport in a manner that the priority is displayed with a higher value in an ascending order of wireless quality (the order from poorer wireless quality) estimated by the wireless quality estimating section 202, or the priority is displayed with a higher value in a sequence from a required quality unsatisfying date (due date for taking measures), which is equivalent to the date at which wireless quality will not satisfy required quality among the sequentially updated dates of interest for analysis, closer to the current date.

In the due-date-for-taking-measures predicting section 205 in the fifth embodiment, estimation of wireless quality from a start date of analysis to an end date of analysis is automated. Thus, an expected date at which wireless quality at a significant spot contained in an area of interest for analysis will not satisfy required quality can be efficiently predicted. Thus, degradation of quality in the future can be easily known on a significant spot by spot basis.

The wireless quality estimating system in accordance with the present invention comprises an environmental information storage (for storing therein information on an environment that affects wireless quality in an area of interest and varies with time), a radio wave propagation analyzing section (for analyzing propagation properties of radio waves), and a wireless quality estimating section (for estimating wireless quality at a spot within the current area of interest using the propagation properties of radio waves analyzed by the radio wave propagation analyzing section and the information on an environment acquired from the environmental information storage). Thus, estimation of wireless quality is achieved while taking account of information on an environment that varies with time.

Moreover, since it is possible to estimate when degradation of quality will occur at an arbitrary spot at which required quality should be promised, it is possible to decide when to take precautionary measures against degradation of quality while additionally taking account of degradation of quality in the future.

A first aspect of the present invention is a wireless quality estimating system for estimating wireless quality at an arbitrary place in an area of interest, comprising: an environmental information storage that stores therein information on an environment corresponding to a temporal change of information on an environment that affects wireless quality; a radio wave propagation analyzing section for analyzing propagation properties of radio waves; and a wireless quality estimating section for estimating wireless quality using at least said propagation properties of radio waves and information on an environment at the specified arbitrary time point.

A second aspect of the present invention is the wireless quality estimating system in the aspect described above, wherein said radio wave propagation analyzing section analyzes propagation properties of radio waves using information on an environment at said specified arbitrary time point.

A third aspect of the present invention is the wireless quality estimating system in the aspect(s) described above, further comprising a quality deciding section for deciding whether wireless quality satisfies required quality in a specific local region based on at least the result of estimation of wireless quality by said wireless quality estimating section.

A fourth aspect of the present invention is the wireless quality estimating system in the aspect(s) described above, further comprising an environmental information predicting section for predicting information on an environment at an arbitrary time point from information on an environment at two or more specific time points.

A fifth aspect of the present invention is the wireless quality estimating system in the aspect(s) described above, wherein said information on an environment is information that includes either or both of a height of a building under construction and traffic.

A sixth aspect of the present invention is the wireless quality estimating system in the aspect(s) described above, wherein the height of a building at an arbitrary time point is predicted using a start date of construction of said building, a date of completion, and the height of said building at the completion.

A seventh aspect of the present invention is the wireless quality estimating system in the aspect(s) described above, wherein traffic at an arbitrary time point is predicted from a time series of traffic in the past.

An eighth aspect of the present invention is the wireless quality estimating system in the aspect(s) described above, further comprising a due-date-for-taking-measures predicting section for receiving said area of interest, a start date of analysis and an end date of analysis as input, and incrementing said specified arbitrary time point from an initial value of said start date of analysis until said end date of analysis is reached, wherein

said wireless quality estimating section estimates wireless quality from said start date of analysis to said end date of analysis using at least information on an environment at the time point sequentially specified by said due-date-for-taking-measures predicting section; and

said due-date-for-taking-measures predicting section predicts an expected date at which wireless quality in a specific local region will exceed required quality in a period from said start date of analysis to said end date of analysis.

A ninth aspect of the present invention is the wireless quality estimating system in the aspect(s) described above, wherein said wireless quality includes at least one of a received signal code power for a desired wave, a ratio of energy per chip of a desired wave to in-band received power density, and a signal-to-interference ratio.

A tenth aspect of the present invention is a wireless quality estimating method in a wireless quality estimating system comprising an environmental information storage that stores therein information on an environment corresponding to a temporal change of information on an environment that affects wireless quality, for estimating wireless quality at an arbitrary place in an area of interest, said method comprising the steps of: analyzing propagation properties of radio waves by radio wave propagation analyzing section; and estimating wireless quality using at least said propagation properties of radio waves and information on an environment at the specified arbitrary time point by wireless quality estimating section.

An eleventh aspect of the present invention is the wireless quality estimating method in the aspect(s) described above, wherein said step of analyzing propagation properties of radio waves by said radio wave propagation analyzing section comprises analyzing propagation properties of radio waves using information on an environment at said specified arbitrary time point.

A twelfth aspect of the present invention is a wireless quality estimating program for causing a computer in a wireless quality estimating system comprising an environmental information storage that stores therein information on an environment corresponding to a temporal change of information on an environment that affects wireless quality, for estimating wireless quality at an arbitrary place in an area of interest, to execute the procedures of: analyzing propagation properties of radio waves; and estimating wireless quality using at least said propagation properties of radio waves and information on an environment at the specified arbitrary time point.

While the present invention has been described with reference to the preferred embodiments and aspects, the present invention is not necessarily limited thereto and can be practiced with several modifications within the spirit and scope of its technical ideas.

The present application claims priority based on Japanese Patent Application No. 2008-087869 filed on Mar. 28, 2008, disclosure of which is incorporated herein in its entirety.

1-20. (canceled)

21. A wireless quality estimating system comprising:
an environmental information storage for storing therein information on an environment for the same object, which affects wireless quality in an area of interest and varies with time;
a radio wave propagation analyzer for analyzing propagation properties of radio waves; and
a wireless quality estimating unit for estimating wireless quality at a spot within said area of interest using the propagation properties of radio waves analyzed by said radio wave propagation analyzer and the information on an environment acquired from said environmental information storage.

22. A wireless quality estimating system according to claim 21, wherein said radio wave propagation analyzer is an analyzer for analyzing propagation properties of radio waves using information on an environment acquired from said environmental information storage.

23. A wireless quality estimating system according to claim 21, further comprising a quality deciding unit for, based on a result of estimation of wireless quality at a spot within an area by said wireless quality estimating unit, deciding whether wireless quality in a region containing the spot within said area satisfies required quality.

24. A wireless quality estimating system according to claims 21, further comprising an environmental information predicting unit for predicting information on an environment at an arbitrary time point using information on an environment at a specific time point.

25. A wireless quality estimating system according to claim 24, wherein said environmental information predicting unit is an predicting unit for predicting a height of a building at an arbitrary time point using a start date of construction of the building, a date of completion, and a height of the building at the completion.

26. A wireless quality estimating system according to claim 24, wherein said environmental information predicting unit is a predicting unit for predicting traffic at an arbitrary time point using traffic in the past.

27. A wireless quality estimating system according to claim 21, further comprising a due-date-for-taking-measures predicting unit for predicting an expected date at which wireless quality in a region containing a specific spot within an area will not satisfy required quality.

28. A wireless quality estimating system according to claim 21, wherein said information on an environment is information including a height of a building under construction and/or traffic.

29. A wireless quality estimating system according to claim 21, wherein said wireless quality includes at least one of a received signal code power for a desired wave, a ratio of energy per chip of a desired wave to in-band received power density, and a signal-to-interference ratio.

30. A wireless quality estimating apparatus comprising:
an environmental information storage for storing therein information on an environment for the same object, which affects wireless quality in an area of interest and varies with time;
a radio wave propagation analyzer for analyzing propagation properties of radio waves; and
a wireless quality estimating unit for estimating wireless quality at a spot within said area of interest using the propagation properties of radio waves analyzed by said radio wave propagation analyzer and the information on an environment acquired from said environmental information storage.

31. A wireless quality estimating method comprising:
analyzing propagation properties of radio waves; and
estimating wireless quality at a spot within an area of interest using said analyzed propagation properties of radio waves and information on an environment acquired from an environmental information storage in which information on an environment that affects wireless quality in said area of interest and varies with time stored.

32. A wireless quality estimating method according to claim 31, wherein said propagation properties of radio waves are analyzed using said acquired information on an environment.

33. A wireless quality estimating method according to claim 31, comprising, based on a result of estimation of wireless quality at a spot within said estimated area, deciding whether wireless quality in a region containing the spot within said area satisfies required quality.

34. A wireless quality estimating method according to claim 31, comprising predicting information on an environment at an arbitrary time point using information on an environment at a specific time point.

35. A wireless quality estimating method according to claim 31, wherein said information on an environment is information including a height of a building under construction and/or traffic.

36. A wireless quality estimating method according to claim 35, comprising predicting a height of a building at an arbitrary time point using a start date of construction of the building, a date of completion, and a height of the building at the completion.

37. A wireless quality estimating method according to claim 35, comprising predicting traffic at an arbitrary time point using traffic in the past.

38. A wireless quality estimating method according to claim 31, comprising:
estimating wireless quality at a spot within said area from a specified start date of analysis to a specified end date of analysis; and
predicting an expected date at which wireless quality in a region containing the spot within said area will not satisfy required quality in a period from said start date of analysis to said end date of analysis.

39. A wireless quality estimating method according to claim 31, wherein said wireless quality includes at least one of a received signal code power for a desired wave, a ratio of energy per chip of a desired wave to in-band received power density, and a signal-to-interference ratio.

40. A non-transitory computer readable storage medium storing a wireless quality estimating program for causing a computer to execute the processing of;
analyzing propagation properties of radio waves; and
estimating wireless quality at a spot within an area of interest using said analyzed propagation properties of radio waves and information on an environment acquired from an environmental information storage in which information on an environment for the same object, which affects wireless quality in said area of interest and varies with time is stored.
